(19) United States
(12) Patent Application Publication
(10) Pub. No.: US 2006/0123095 A1
(43) Pub. Date: Jun. 8, 2006

(54) Method of and system for presenting a document, media player, information carrier and computer program product

(75) Inventors: Warner Rudolph Theophile Ten Kate, Eindhoven (NL); Ramon Antoine Wiro Clout, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/538,215

(22) PCT Filed: Dec. 1, 2003
(86) PCT No.: PCT/IB03/05592

§ 371 Date: Jun. 9, 2005

(30) Foreign Application Priority Data
Dec. 11, 2002 (EP) 02080227.8

(51) Int. Cl. G06F 15/16

(52) U.S. Cl. 709/217

(57) ABSTRACT

The invention relates to a method of presenting a document comprising: requesting by a user for the document to be presented (S200); determining if the document is present within a collection comprising those documents that are allowed to be presented to the user (S202); presenting the document to the user if the document is present within the collection (S204).

The invention relates to a method of presenting a document.

The invention further relates to a system of presenting a document.

The invention further relates to a media player comprising such a system.

The invention further relates to an information carrier for use in such a media player.

The invention further relates to a computer program product designed to perform such a method.

An embodiment of such a method and system is known from a, so called, “walled garden”. On the Internet, a walled garden is an environment that controls the user's access to Web content and services. In effect, the walled garden directs the user's navigation within particular areas, to allow access to a selection of material, or prevent access to other material. An Internet service provider (ISP) may or may not allow users to select some of the Web sites contained or barred from the garden. Although the walled garden does not actually prevent users from navigating outside the walls, it makes it more difficult than staying within the environment. ISPs want to fence in users for a number of reasons. For example, a walled garden can be used to prevent access to inappropriate Web sites for children. However, a common reason for the construction of walled gardens is for the profits they generate: vendors collaborate to direct consumer's Internet navigation to each others' Web sites and to try to keep them from accessing the Web sites of competitors. Also, Web sites can relate to some other content provision mechanism, such as a television broadcast or a DVD movie disc. The Web sites form part of the main content provided by that other mechanism. The walled garden restricts the scope of Web sites to those sites that are related to that main content.

It is an object of the invention to provide a method according to the opening paragraph that creates a walled garden in an improved way. To achieve this object, the document is comprised within a collection of documents that can be presented to a user and the method comprises requesting by the user for the document to be presented; determining if the document is present within a sub-collection of the collection, the sub-collection comprising those documents, of the collection of documents, that are allowed to be presented to the user; and presenting the document to the user if the document is present within the sub-collection. Documents can be identified and referenced by means of a URI or URL (Uniform Resource Identifier or Uniform Resource Locator; [IETF, RFC 2396, http://www.ietf.org/rfc/rfc2396.txt, August 1998). The sub-collection can contain a list with all the Uniform Resource Locators (URLs) of the documents that are allowed to be visited or accessed by a user. By using such a list it can be checked if a user tries to access or visit documents that are not allowed. Because of using the list, the documents themselves can still contain references, i.e. hyperlinks, to documents that are not within the list. Traversing these hyperlinks enables de-coupling of the contents of a document from the walled garden that a user is allowed to visit.

An embodiment of the method is described in claim 2. By storing the sub-collection on a location, the sub-collection can be retrieved from this location. Furthermore, the sub-collection can be changed at the location itself.

An embodiment of the method is described in claim 3. By storing the sub-collection on an information carrier, such as a Digital Versatile (or Video) Disk (DVD), the content provider of the DVD can direct a user to the content provider's internet site. Furthermore, the sub-collection can depend upon the particular contents that's on the disc, for example a movie, music, a video game or an other interactive application, thereby directing a user to internet documents related to the contents on the DVD. A further advantage is, that the content provider can set and control the scope of the walled garden, while player manufacturers may remain offering their customers a device without limited web access. By storing the sub-collection onto an internet site, the walled garden can be retrieved from the internet site and the content provider can easily update the walled garden list on the internet site. By storing the Walled Garden list at the broadcast station, the walled garden list can be sent to a user together with the broadcast stream that describes for example an interactive application.

An embodiment of the method is described in claim 4. If a user requests a document that is allowed to be displayed, the interactive presentation can continue playing. Thereby, allowing the user to continue navigating within the walled garden as defined by the content provider. Furthermore, if a user requests to navigate to a document that is not within the walled garden the interactive presentation can discontinue playing. In the latter case, the content provider can control that a user is not able to navigate to documents that are not allowed as long as the DVD of the content provider is playing.

An embodiment of the method is described in claim 5. By providing a reference to the sub-collection, the sub-collection can be retrieved indirectly. Furthermore, only the reference needs to be distributed to the users which saves memory space and the content provider can update the sub-collection at a central place for all users that have the reference to the specific sub-collection.

It is a further object of the invention to provide a system according to the opening paragraph that creates a walled garden in an improved way. To achieve this object, the document is comprised within a collection of documents that can be presented to a user, and the system comprises determining means conceived to determine if the document is present within a sub-collection of the collection, the sub-collection comprising those documents, of the collection of documents, that are allowed to be presented to the user; and presenting means conceived to present the document, that the user requests to be presented, if the document is present within the collection.

An embodiment of the system is described in claim 7.

It is a further object of the invention to provide an information carrier according to the opening paragraph that creates a walled garden in an improved way. To achieve this object, the information carrier for use in the media player comprises an interactive presentation and a collection comprising those documents that are allowed to be presented to a user.

These and other aspects of the invention will be apparent from and elucidated with reference to the embodiments described hereinafter as illustrated by the following Figures:

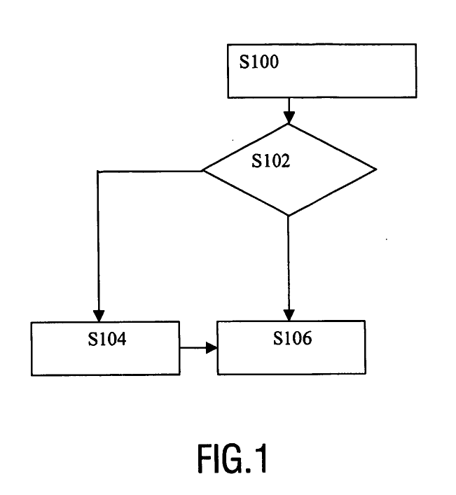

FIG. 1 illustrates presenting an application by a media player in a schematic way;

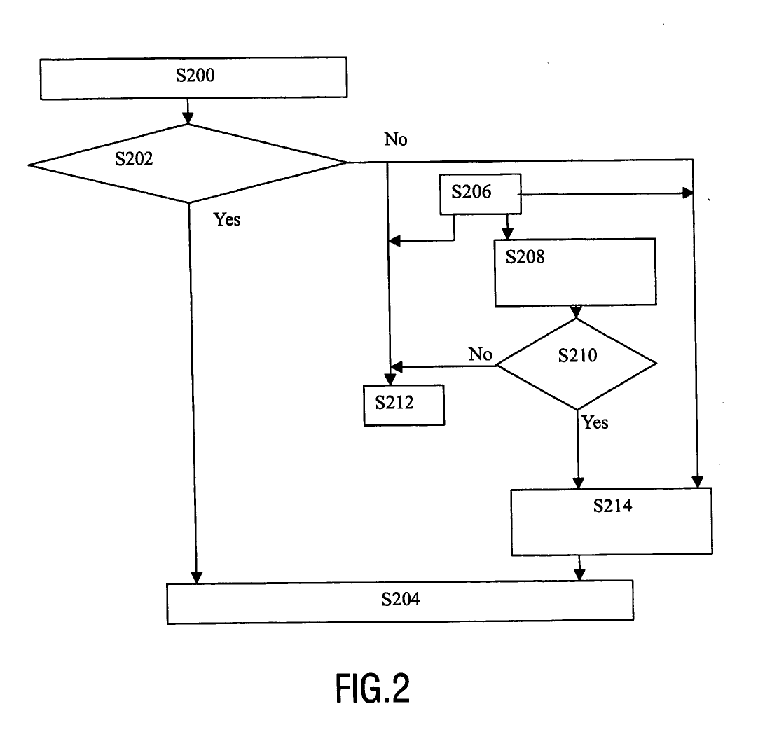

FIG. 2 illustrates presenting a document in a schematic way;

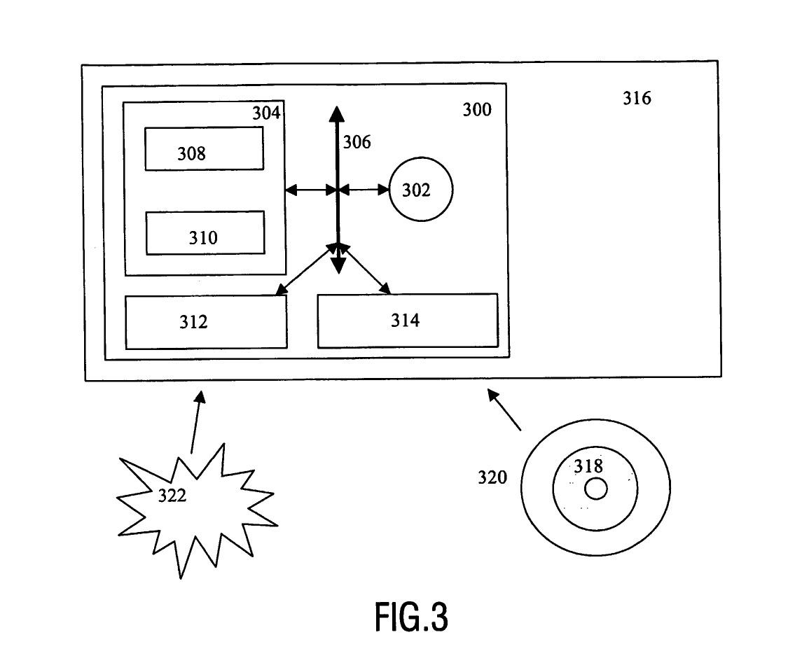

FIG. 3 illustrates a DVD player 316 comprising a system 300 according to the invention in a schematic way.

Nowadays, more and more devices become internet enabled such as mobile phones set-top boxes, television sets, etc. This creates opportunities for defining an interactive and internet-enabled disc format for DVDs (see DVD Forum news Vol. 15, July 2002) thereby opening the possibilities for the content providers, such as movie studios, to create interactive presentations that, e.g., enhance the current video material with additional content and other interactions such as quizzes. One such other form is the access of content at the content provider's Web site by enabling a user to browse that site. Preferably, content providers do not want the users to surf away from their site to other, sometimes competitor's, sites. Thus, they want to restrict the scope of sites that can be visited to a so called “Walled Garden”. The Walled Garden's scope is dependent on which provider has created the disc at hand. Also, the scope of the Walled Garden may change over time for a given disc and preferably, the manufacturer of the disc player doesn't want to limit the surfing capabilities of its player.

FIG. 1 illustrates presenting an application by a media player in a schematic way. Within step S100, the user selects a disc from his collection and loads the disc into his player. For example, A DVD player into which a DVD is loaded. The player reads the lead information and discovers it is an interactive disc. The player searches for the file on the disc that describes the application, i.e. that describes the presentation and interaction of the content items, which are usually media items. Most of the content items, if not all, are also stored on the disc. Other places can be on the internet. An example of such a file describing the application is a Synchronized Multimedia Integration Language (SMIL) document as defined by the World Wide Web Consortium (W3C), http://www.w3.org/TR/smil20/, August 2001. Another example is a java program. Yet another example is a Hypertext Markup Language (HTML) file extended with an ECMAScript. ECMAScript is a standard script language, and the official standard, ECMA-262, was developed under the auspices of the European Computer Manufacturers Association.

In the following a SMIL document is referred to, when referring to any of these application descriptions.

The player preferably includes a browser program that is responsible for the control of the application. Through this browser program the user is able to control the course of the application. It enables the user to do such matters as pausing, resuming, stopping, fast forwarding, slowing, or slow motion, and navigating, like jump forward or jump backward, the application. Note, that these user actions do not represent interaction with the application itself; that's described in the application (SMIL) document. An example of such an interaction with the application is the user making a choice whether a character in the (interactive) movie enters a house through the main entrance or the back door. Another example is the user “clicking” (or whatever response mechanism is in place) an alert that pops up on the screen, causing additional information to be presented to the user. That additional information could be a Web site, for example. The user can input his choices through a remote control or other known ways to provide input to a player.

The player loads the SMIL document in the player's browser, which subsequently starts the application. It is also conceivable that an explicit user action is required before the application will start; the player will load and prepare, but awaits the user's commands before starting. The player takes care that the different content items are presented or reproduced at the correct time and place as described by the SMIL document.

The next step S102 occurs when the user interacts with the presentation. Within this step S102, the type of input of the user interaction is determined. It is distinguished whether the user interaction applies to the browser program, or to the presentation. The browser program is part of the player. It is loaded with the application description (SMIL document) that resides on the disc. The browser program executes the rendition of the application. User input that controls the course of the application, i.e. applies to the browser program, is handled by this browser program. For example, a stop command will end the further rendition of the application. User input that responds to what is presented or rendered, i.e. user interaction, is handled according to the application description. It is still executed by the browser program, but as part of the application rendition.

Within step S104, the user input command that controls the course of the application is handled; and within step S106, the user input response that controls what is presented or rendered is handled according to the descriptions in the document leading to a corresponding change in the presentation.

Next to controlling the course of the application, the browser program can also load new application descriptions, hence offering the user another presentation with other interactions. Such another application description can be fetched from the same disc, can be retrieved from the internet, or can be “home made” by the current or other user. One cause of loading the browser program with a new application description can be an interaction within the current application. For example, the SMIL document includes a hyperlink to that new application description. The user interaction to traverse that hyperlink causes the current application to stop and to load the browser program with the new description that is fetched from the location pointed to by the hyperlink. Instead of stopping it is also possible that the current application pauses or continues. This depends on the actual application description. The SMIL language provides for constructs to describe the intended behavior. It also depends on the resource capabilities of the player to what extent rendition remains feasible, but, for example, in case the hyperlink is adding an additional image, it can be feasible that the current application remains running.

Another cause of loading the browser program with a new application description can be an explicit user command to the browser program to do so. For example, the user interface provides for a way to enter the URL of that new SMIL document to be loaded. The user command to load the new document causes the current application to stop and to load the browser program with the new description that is fetched from the location pointed to by the entered URL. Instead of stopping it is also possible that the current application pauses or continues. For example, the user wishes to surf around on the internet while keeping the application continuing in the background, e.g., only the sound is audible, or the video appears in a picture-in-picture like sub-window. This could have been initiated by the application in the first place, where a hyperlink has opened for displaying the web site of the studio that produced the disc's movie. So, instead of entering explicitly the URL of a new location, the user could also have “clicked” a hyperlink from the additionally loaded sites.

FIG. 2 illustrates presenting a document in a schematic way. Within step S200 a user requests for displaying a web site in the setting of a Walled Garden. The content provider of the disc that is currently in the player, wishes to constrain the set of sites that the user may visit while using the disc. Within step S202, the browser program determines if the requested site is within the walled garden, by checking a list containing the URLs of allowed sites that can be visited. The reference to the Walled Garden list is stored on the disc, for example at a location of the disc's file system. It can also be stored as part of a document stored on the disc, where the document contains the application description. Multiple documents may reside on one disc, each carrying another such reference. For example, the document may be a SMIL document, a Java program class file, or a piece of ECMAScript as part of an Extensible Hypertext Markup Language (XHTML) document. In case of the SMIL example the reference could be represented as an XML fragment, e.g., as follows:
<walledGarden ref=“http://studio.com/movie/disc/garden.1st”/>

In case of the Java or ECMAScript example the reference could be represented as an API call, e.g., as follows:
walledGarden.set(“http://studio.com/movie/disc/garden.1st”);

It should be noted that instead of providing a reference to a list, as in the above examples, the list itself can also be enumerated, or a combination of these. Also, the list itself can be stored on the disc, such that the reference points to a location on the disc or in the document, rather than to a location on the internet. When referencing a location on the internet, flexibility can be obtained, since the list can be maintained and be updated (remove stale URLs, add new ones). The list can also be made dynamic, e.g. be made dependent of privileges acquired by the user.

If the site is within the walled garden list, the current application that is being run by the player is not affected, i.e. continues playing, and step S204 is performed.

If the site is not within the walled garden list, either step S206, S212 or step S214 is performed. As long as the browser program is loaded with the application, i.e. is rendering the application, navigation outside the walled garden is prohibited by the browser.

Within step S204, the requested site is fetched and presented to the user.

Within step S206, the user is informed that he or she tries to access a site that is not within the list of allowed sites and either step S212, S208, or S214 is performed. For example step S208 is performed, in the case that the “forbidden” site is offered as a hyperlink in the currently displayed page.

Within step S208, a more user-friendly user interface is provided to the user, indicating that the browser program doesn't display or offer the site in the first place, based on the provided list of allowed sites because of the loaded disc. In a dialog it asks the user whether he wishes to continue possibly at cost of ending the running application's presentation.

Within step S210 the user's response is evaluated. If the user wishes to stay in the walled garden, i.e. the application's presentation continues, step S212 follows. If the user confirms to continue to access the “forbidden site”, step S214 follows.

Within step S212, the browser program refuses to display the requested site. The requested site is not offered to the user and the application continues running on the player.

Within step S214, the application is stopped because the user requested a site outside the walled garden. Then, step S204 follows: the requested document is fetched and presented to the user.

Steps S212 and S214 can be performed without informing the user what is happening. This may give the user the impression that the player is broken (because fetching does not succeed, or the application discontinues) and leading to complaints to the manufacturer. Therefore, it is better that the browser program informs the user that the site is currently inaccessible, because of the loaded disc. Therefore, in a dialog it can ask the user whether he wishes to continue. The browser program can also skip this information to the user and/or conducting the dialog, and immediately continue to fetch the requested page. For example, the user may have set in a preference list available to the player that he always wishes to stay within the walled garden, e.g. following the path S206-S212. This saves the user additional interaction like “button clicking”. Likewise, he or she may have set that the presentation can be stopped, following the path straight to S214. In any case, when the browser program leaves the Walled Garden to fetch an outside page, it can stop the running application so as to obey the Walled Garden requirement by the application's or disc's producer.

A special situation is the case where the producer of disc doesn't want to provide a Walled Garden restriction. In such situations it is likely that the reference doesn't exist on the disc and a default player behavior will take over (being no restricted surfing). If a producer wishes to disable surfing at all, an explicit call to the Walled Garden restriction is needed, being a reference to an empty list. It is clear that other definitions are conceivable to deal with these special cases of no or full restriction, as well as the definition of default behavior.

The concept of Walled Garden also occurs in other use cases. For example, parental control is a form of Walled Garden, in which parents restrict the scope of sites their children are allowed to visit. The same mechanism can be used here. The parents set on the player the list of allowed sites, for example by entering a reference to a list maintained by a corresponding service provider.

Walled Gardens can also be combined. For example, the Parental Control case can be combined with the disc's Walled Garden by intersecting the two lists.

In the above description the Walled Garden list is assumed to be an exhaustive listing of allowed sites and or pages. In the implementation this can be realized by using other constructs such as denials. Since the number of internet sites is virtually unlimited, denials can be evaluated on a access-per-access basis: upon the user's request for a site the URL is checked for the denial (and not matched with the URLs in an existing list). Then, a Walled Garden list is provided containing those internet sites that a user is not allowed to visit.

FIG. 3 illustrates a DVD player 316 comprising a system 300 according to the invention in a schematic way. The system 300 comprises a processor 302, DVD drive with appropriate DVD driver software 314, internet connection with appropriate internet driver software 312 and a general purpose memory 304 that all communicate with the processor 302 through software bus 306. The memory 304 comprises computer readable code 308 and 310. The computer readable code 308 is designed to translate documents into displayable format. This displayable format can for example be displayed by a CRT display or plasma display. The computer readable code 310 is designed to determine if the requested site to be displayed by a user is within the walled garden as previously described. The DVD driver software 314 is designed to read the information from DVD disc 320. This information comprises the walled garden list and for example a movie with its applications. The internet driver software 312 enables connection of the system to the internet 322 such that a user is able to request for documents that reside on the world wide web to be displayed. The information on the DVD disc 320 can be read from sectors 318 that are written. In stead of a DVD player, a DVD+RW (read write), a CD-I (interactive), BluDisc, Video-CD, etc. can be used too that support interactive navigation through the internet. It is also possible that an interactive television program is received through a transport stream as defined in the Multimedia Home Platform as available from http://www.mhp.org. In this case, the Walled Garden list can be received through the transport stream or as comprised within a computer program (for example java program) that describes the interactive television program.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. Method of presenting a document, the document being comprised within a collection of documents that can be presented to a user, the method comprising:
requesting by the user for the document to be presented;
determining if the document is present within a sub-collection of the collection, the sub-collection comprising those documents, of the collection of documents, that are allowed to be presented to the user;
presenting the document to the user if the document is present within the sub-collection.

2. Method according to claim 1, comprising reading the sub-collection from a location.

3. Method according to claim 2, wherein the location is one of an information carrier, an internet site or a broadcast station.

4. Method according to claim 2, comprising:
playing an interactive presentation from the location; and
continuing playing the interactive presentation if the document, that the user requested, is present within the sub-collection comprising those documents that are allowed to be presented to the user.

5. Method according to claim 2, wherein the location comprises a reference to the sub-collection.

6. System for presenting a document, the document being comprised within a collection of documents that can be presented to a user, the system comprising
determining means conceived to determine if the document is present within a sub-collection of the collection, the sub-collection comprising those documents, of the collection of documents, that are allowed to be presented to the user; and
presenting means conceived to present the document, that the user requests to be presented, if the document is present within the sub-collection.

7. System according to claim 6, comprising:
reading means conceived to read the sub-collection from an information carrier; and
playing means conceived to continue playing an interactive presentation if the document, that the user requested, is present within the sub-collection comprising those documents that are allowed to be presented to the user.

8. Media player comprising the system according to claim 6.

9. Information carrier for use in the media player according to claim 8, the information carrier comprising an interactive presentation and a sub-collection comprising those documents that are allowed to be presented to a user.

10. Computer program product designed to perform the method according to any of the claims 1 to 5.
